(19) United States
(12) Patent Application Publication
(10) Pub. No.: US 2008/0057175 A1
(43) Pub. Date: Mar. 6, 2008

(54) Tea Flavouring

(75) Inventors: Rainer Barnekow, Marienmunster (DE); Martina Batalia, Boffzen (DE)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: SYMRISE GMBH & CO. KG, Holzminden (DE)

(21) Appl. No.: 11/572,666

(22) PCT Filed: May 23, 2005
(86) PCT No.: PCT/EP05/52346

§ 371 Date: Oct. 31, 2007

(30) Foreign Application Priority Data
Jul. 26, 2004 (DE) 10 2004 036 187.8

(51) Int. Cl. A23F 3/40

(52) U.S. Cl. 426/597

(57) ABSTRACT

The invention relates to processes for the flavouring of tea, especially tea for tea bags, and to the flavoured tea itself.

The present invention relates to tea flavoured with a spray-dried flavouring, and to its preparation and use.

In terms of this invention, tea is both the tea prepared by conventional processes from leaves, leaf buds and/or tender stalks of the tea bush Camellia sinensis (tea bush) (tea in the narrower sense), and plant parts which do not originate from the tea bush and are prepared and determined for use in the manner of tea in the narrower sense (tea in the broader sense), as well as mixtures of tea in the broader and narrower sense. The term ‘tea particles’ is understood hereafter as meaning both particles of tea in the narrower sense and plant parts of tea in the broader sense.

In particular, in terms of the present invention, tea or tealeaves are understood as meaning a leaf tea of the leaf grade “broken”, “fannings” or “dust”. Fannings are small sievings used almost exclusively for tea bags. Fannings conventionally have a tealeaf or particle size ranging from 0.5 to 2 mm and frequently of 0.7 to 1.5 mm. Teas corresponding to the leaf grade “broken” conventionally include constituents with a tealeaf or particle size of up to 1.5 cm.

Tea in the narrower sense is especially black tea, oolong tea, green tea, including pu-errh tea, and yellow tea. Tea in the broader sense is especially fruit and/or herb tea based e.g. on roolbos, rose hip, hibiscus, apple, orange, peppermint or balm.

It has been known for a long time to flavour tea in the narrower and broader sense, conventionally using either liquid flavourings, solid flavourings, i.e. flavourings applied to solid carriers or included in solid carriers, or small pieces of dried plants.

In the case of liquid flavourings, the flavouring is not protected from evaporation or oxidation; also, flavouring with liquid flavourings can lead to undesirable agglomeration of the tea. In the flavouring of tea with solid flavourings, granules or agglomerated powders are used because these larger particles have a lesser tendency to demix. Conventional particle sizes of flavouring granules are 500 μm to 2 mm.

A simple method of flavouring tea with a solid flavouring has now been sought which does not result in a demixing of tea and solid flavouring.

The present invention therefore provides a process for the flavouring of tea, comprising the following steps:
a) tea particles to be flavoured are placed in a mixer,
b) the tea particles placed in the mixer are treated with a neutral oil in order to wet the surface of the tea particles, and
c) spray-dried flavouring is intermixed with the tea particles wetted with the neutral oil.

The wetting of the tea particles, especially tealeaves, with neutral oil and the subsequent addition of spray-dried flavouring extensively prevents the demixing of tealeaves and spray-dried flavouring. Demixing can be extensively avoided by the adhesive attachment of the spray-dried flavouring to the surface of the tealeaves.

The tealeaves flavoured in this simple and cost-effective manner have a protected flavouring and also a very low dust content.

By virtue of said properties, the flavoured tea particles and/or tealeaves according to the invention are particularly suitable for filling into, and use in, tea bags.

The invention therefore further relates to tea bags containing tea flavoured according to the invention, especially tea of the leaf grade “fannings” and/or “broken” flavoured according to the invention.

Particularly preferably, the process is carried out by
a) placing tealeaves, especially of the leaf grade “fannings” and/or “broken”, preferably in a fluidizing mixer.
b) applying neutral oil to the preferably fluidized tealeaves.
c) adding a spray-dried flavouring to the tealeaves treated with neutral oil, and
d) optionally continuing to mix the resulting mixture.

The further mixing can be used in particular to mix other constituents into the tea. The subsequent mixing of other constituents into a tea flavoured according to the invention is particularly advantageous if these constituents do not withstand a mixing stress of long duration, examples being flowers and other fragile constituents.

Flavourings for the flavouring of tea according to the invention are usually liquid mixtures generally of volatile components, said mixtures sometimes being of complex composition. Granules or particles containing flavourings are required for various purposes and represent a common form of presentation in the flavouring industry. The encapsulation of flavourings by means of spray drying is conventional in the industry, as described e.g. in U.S. Pat. No. 3,159,585, U.S. Pat. No. 3,971,852, U.S. Pat. No. 4,532,145 or U.S. Pat. No 5,124,162. Spray-dried flavourings are commercially available in many different types and particle sizes.

Conventional spray-dried flavourings include at least one carrier, a flavouring or an individual flavouring substance, and other substances such as an emulsifier.

The concentration of flavouring in the spray-dried flavouring to be used according to the invention can be varied within wide limits depending on the requirement and the desired sensory profile. The concentration of flavouring is conventionally in the range from 1 to 60 wt.% and usually in the range 5 to 40 wt.%, based on the total weight of spray-dried flavouring.

The carrier used for the flavourings in the spray-dried flavourings to be used according to the invention can be individual substances or mixtures of substances. Advantageous carriers are carbohydrates and/or carbohydrate polymers (polysaccharides). Examples of carriers which may be mentioned are hydrocolloids such as starches, degraded starches, chemically or physically modified starches, modified celluloses, gum arabic, gum ghatti, tragacanth, karaya, carrageenan, guar seed flour, carob seed flour, alginates, pectin, inulin or xanthan gum.

Preferred carriers are maltodextrins, those with DE values ranging from 15 to 20 being advantageous here.

The degree of decomposition of the starch is measured by the index “dextrose equivalent” (DE), which can take the limiting values 0 for long-chain glucose polymer and 100 for pure glucose.

Examples of suitable flavourings are ethereal oils, fractions thereof or individual flavouring substances.

The following may be mentioned as examples: extracts of natural raw materials, such as ethereal oils, concretes, absolutes, resins, resinoids, balsams, tinctures such as aniseed oil; bergamol oil; lemon oil; eucalyptus oil; grapefruit oil; camomile oil; lime oil; clove oil, orange oil; peppermint oil; rosemary oil; sage oil; Japanese anise oil; thyme oil; vanilla extract; juniper oil; wintergreen oil; cinnamon leaf oil; cinnamon bark oil; and fractions thereof or ingredients isolated therefrom.

Individual flavouring substances which can be constituents of the flavouring belong e.g. to the following classes of substances; aliphatic esters (saturated and unsaturated), e.g. ethyl butyrate, allyl caproate; aromatic esters, e.g. benzyl acetate, methyl salicylate; organic aliphatic acids (saturated and unsaturated), e.g. acetic acid, caproic acid; organic aromatic acids; aliphatic alcohols (saturated and unsaturated); cyclic alcohols, e.g. menthol; aromatic alcohols, e.g. benzyl alcohol; aliphatic aldehydes (saturated and unsaturated), e.g. acetaldehyde; aromatic aldehydes, e.g. benzaldehyde; vanillin; ketones, e.g. menthone; cyclic ethers, e.g. 4-hydroxy-5-methylfuranone; aromatic ethers e.g. p-methoxybenzaldehyde, guaiacol; lactones, e.g. gamma-decalactone; and terpenes, e.g. limonene, linalool, terpinene, terpineol, citral.

The following are preferred flavourings within the framework of the present invention: berry, citrus, stone fruit, vanilla, spice, herb and mint. Particularly preferred flavourings are lemon and orange. When added to tea as liquids, these flavourings are very susceptible to oxidation, so they easily give rise to undesirable sensory off-notes. The process according to the invention makes it possible to prepare teas, especially teas for tea bags, which have a greatly reduced tendency to give rise to sensory off-notes, without demixing of the tea and the flavouring taking place.

Conventional additives and ingredients, such as food colours, sweeteners, antioxidants, culinary acids like citric acid, taste modifiers like sodium glutamate, vitamins, minerals, juice concentrates, etc. can also be added to the spray solution for preparing the spray-dried flavourings to be used according to the invention, so the spray-dried flavourings used according to the invention can also contain such additives.

The spray-dried flavourings used according to the invention have a mean particle size (median value) of 10 to 100 micrometres, preferably a median value greater than or equal to 10 and less than or equal to 70 micrometres, and particularly preferably a median value greater than or equal to 15 and less than or equal to 50 micrometres. The demixing of tea particles (especially tealeaves) and spray-dried flavouring is most extensively avoided in the last-mentioned range. The most extensive to complete absence of demixing is particularly striking in the case of flavoured tea in the narrower sense and teas with a medium and coarse particle size of up to 2.5 mm, especially broken-grade and fannings-grade teas. Surprisingly, it has been ascertained that spray-dried flavourings according to the invention with a mean particle size of up to 100 μm, especially with a mean particle size of 10 to 50 μm, adsorb particularly well onto tea constituents wetted with neutral oil, and exhibit only a very low tendency to demix.

The advantageous amount of spray-dried flavouring is 0.1 to 8 wt.%, preferably from 0.5 to 5 wt.% and particularly preferably form 0.8 to 4 wt.%, based on the initial weight of tealeaves.

“neutral oil” is understood in the present invention as meaning a substantially non-tainting triglyceride such as a vegetable oil. Particularly suitable non-tainting triglycerides are those with identical or different C6 to C10 fatty acid radicals (MCT, medium-chain triglycerides), which additionally have outstanding spreading and wetting properties on tealeaves. In less preferred embodiments of the invention, polyethylene glycol (PEG), glycerol and/or triacetin can also be used as neutral oils. These substances are less preferred because they do not spread as well as triglyceride neutral oils, some of them are hygroscopic and they can promote the undesirable agglomeration of tea particles and tealeaves.

The advantageous amount of neutral oil is 0.1-3 wt.%, preferably 0.5 to 2 wt.%, based on the initial weight of tea particles, especially tealeaves. This adequately wets the tea particles without giving rise to an undesirable piling of the tea, especially on brewing.

A perfume or aromatizing substance can also be added to the neutral oil in order to scent the tea. This perfume or aromatizing substance can be solid or liquid.

In general terms, the best results are achieved by a process in which the tea is placed in a fluidizing mixer, examples of typical mixers being ploughshare mixers (manufactured by Lödige)or multistream fluidic mixers (manufactured by Gericke).

After the tea has been fluidized by the mixer, the neutral oil is sprayed onto the tealeaves by means of a nozzle. The spray-dried flavouring is then added to the fluidized tea. This causes the spray-dried flavouring to be distributed and bound to the surface of the tealeaves.

The mixture is mixed further until the spray-dried flavouring is sufficiently distributed in the tea.

The invention is illustrated in greater detail with the aid of the following Examples without thereby limiting the subject of the invention or the scope of protection:

### EXAMPLE 1

An orange-coloured spray-dried flavouring (containing maltodextrin (DE: 18-20), dextrose, gum arabic, orange oil, acetaldehyde, colourant (to allow visual assessment of mixing quality) and the antioxidant ascorbyl palmitate) having the following particle size distribution was prepared via a pressure nozzle:

D(v 0.1): 15.8 micrometres,

D(v 0.5): 48.02 micrometres,

D(v 0.9): 96.4 micrometres. 850 g of fannings-grade black tea are placed in a 5 litre Lödige ploughshare mixer. The tealeaves are premixed and fluidized for 10 seconds.

Without interrupting the mixing process, 6 g of a fine mist of neutral oil (aerosol of MCT oil) are sprayed onto the fluidized tealeaves by means of a one-fluid or two-fluid nozzle. This takes about 60 seconds.

Without interrupting the mixing process, 40 g of the above-mentioned orange-coloured spray-dried flavouring are then added to the mixture and the whole mixture is mixed for a further 60 seconds.

### EXAMPLE 2

A spray-dried vanilla flavouring (containing maltodextrin (DE: 18-20), dextrose, gum arabic and vanilla) having the following particle size distribution was prepared via a pressure nozzle:

D(v 0.1): 14.1 micrometres,

D(v 0.5): 47.08 micrometres,

D(v 0.9): 85.3 micrometres.

800 g of rooibos tea are placed in a 5 litre Lödige ploughshare mixer. The tealeaves are premixed and fluidized for 10 seconds.

Without interrupting the mixing process, 5 g of a fine mist of neutral oil (aerosol of MCT oil) are sprayed onto the fluidized tealeaves by means of a one-fluid or two-fluid nozzle. This takes about 60 seconds.

Without interrupting the mixing process, 33 g of the above-mentioned adhesive, spray-dried flavouring are then added to the mixture and the whole mixture is mixed for a further 60 seconds.

### EXAMPLE 3

A spray-dried vanilla flavouring (containing maltodextrin (DE: 18-20), dextrose, gum arabic and vanilla) having the following particle size distribution was prepared via a pressure nozzle:

D(v 0.1): 14.1 micrometres,

D(v 0.5): 47.08 micrometres,

D(v 0.9): 85.3 micrometres.

650 g of broken-grade (large-cut) black tea are placed in a 5 litre Lödige ploughshare mixer. The tealeaves are premixed and fluidized for 10 seconds.

Without interrupting the mixing process, 3.6 g of a fine mist of neutral oil (aerosol of MCT oil) are sprayed onto the fluidized tealeaves by means of a one-fluid or two-fluid nozzle. This takes about 60 seconds.

Without interrupting the mixing process, 24 g of the above-mentioned adhesive, spray-dried flavouring are then added to the mixture and the whole mixture is mixed for a further 60 seconds.

The flavouring operation was not expected to be stable to demixing in this specific case.

### EXAMPLE 4

### Determination of Demixing (Segregation)

The demixing (segregation of a mixture of solids is understood as meaning the undesirable separation of one or more components of the mixture.

Demixing usually occurs as a result of vibration, transfer, transportation or other movement of the mixture.

the tendency of the mixture to demix was assessed as follows:
a) Visual evaluation: by visual comparison of several random samples in respect of the distribution of flavouring in the tea.
b) Sensory taste evaluation: various random samples of the mixture were tested by a panel in a triangular test and the sensory deviation in respect of the flavouring intensity was assessed.
c) Sieve analysis: 100 g of a sample of the mixture were passed through a 100 μm sieve. The smaller the fraction with a particle size of <100 μm, the more stable was the mixture to demixing.

1. A process for the flavouring of tea, comprising the following steps:
a) placing tea particles to be flavoured in a mixer,
b) treating the tea particles with a neutral oil in order to wet the surface of the tea particles, and
c) mixing spray-dried flavouring with the oil wetted tea particles.

2. A process according to claim 1, characterized in that, in step c), the tea particles to be flavoured have a size of up to 1.5 cm.

3. A process according to claim 1, characterized in that the spray-dried flavouring has a mean particle size of 10 to 100 μm.

4. A process according to claim 1, characterized in that a fluidizing mixer is used to intermix the spray-dried flavouring in step c).

5. A process of making a flavored tea by mixing hot water and tea particles comprising a spray-dried flavouring with a mean particle size of 10 to 100 μm.

6. A flavoured tea prepared by a process according to claim 1.

7. A flavoured tea comprising tea particles with a size of up to 1.5 cm, the surface of the tea particles being wetted with a neutral oil, and spray-dried flavouring adsorbed thereon.

8. A tea bag containing a flavoured tea according to claim 7.
